(19) United States
(12) Patent Application Publication
(10) Pub. No.: US 2011/0284173 A1
(43) Pub. Date: Nov. 24, 2011

(54) INSECT PROTECTION FABRIC

(76) Inventors: Norbert Neher, Aldingen (DE); Frauke Susanne Hänsch, Karlsruhe (DE)

(21) Appl. No.: 13/143,289

(22) PCT Filed: Jan. 8, 2010
(86) PCT No.: PCT/EP2010/050142

§ 371 Date: Jul. 5, 2011

(30) Foreign Application Priority Data
Jan. 9, 2009 (EP) 09150333.4

(51) Int. Cl. E06B 9/52; D04H 13/00

(52) U.S. Cl. 160/369; 28/140; 160/368.1

(57) ABSTRACT

The invention relates to an insect protection device for protecting openings such as windows or doors against the entry of insects, comprising a holder (10) that can be installed in front of the opening and an insect protection fabric (12), which is held on the holder and which comprises warp and weft threads (16, 18), which are connected to each other in a grid-like manner, wherein the warp threads (16) and the weft threads (18) lie one upon the other and are connected to each other by binding threads (20). For an exceptionally regular and stable grid structure, it is proposed that the warp threads (16) and weft threads (18) lie one over the other in a separate thread plane in each case and extend in straight lines.

The invention relates to an insect protection device for shielding openings such as windows or doors against the entry of insects, having a holder which can be fitted in front of the opening and having an insect protection fabric which is held thereon and has warp and weft threads linked together in the manner of a grid. The invention further relates to a method for producing an insect protection fabric for an insect protection device of this kind.

Insect protection devices of this kind should maintain an appearance which is as inconspicuous as possible (easy to see through) and a high air throughput, with it being necessary at the same time for the openings in the fabric to be so small that even very small insects, such as midges, cannot slip through. For this purpose, a plastic-coated fiberglass fabric in a plain weave has become established hitherto on the market. In this case, a fiberglass thread ensures the stability and tearing strength of the fabric, while a plastic coating is intended to allow the UV and weather protection, coloring and crossing point welding of the fabric. With this configuration, it is scarcely possible to fall below a thread diameter of about 0.3 mm, however. With a smaller diameter, the function of the plastic coating is impaired or the fiberglass thread becomes too weak. On account of the plain weave, the weft threads pass through alternately over and under the individual weft threads. The position of the threads thus changes from one mesh to another, from the right-hand to the left-hand side or from the top side to the underside of the fabric. A disadvantage in this case is the low displacement resistance in the case of relatively large grid openings. In plain weave, the mutual normal force of the crossed threads is achieved only by the bending radii of the threads, and so, in the case of more open fabrics or thinner threads, this force becomes less and less. This also makes it more difficult to handle the fabric during the production process.

DE 101 53 248 A1 discloses an insect protection fabric, which serves at the same time as an electrosmog shield, and in which warp threads extending in the form of waves are twisted with a leno weave with in each case one shield thread. In order to achieve frictional fixing, both the warp threads and the shield threads loop linearly (approximately 180°) around the weft thread cover and cross one another approximately at right angles between the weft threads. On account of the mutual looping of binding and warp thread at the crossing point, a normal force acts at this point perpendicularly to the plane of the fabric and, on account of the bendability and the unspecified preferential direction of the thread materials, causes a displacement of the crossing point and thus a deflection of the warp thread into the plane of the weft thread. Although twisting in the form of waves leads to a bumpy fabric appearance, it does enable the incorporation of electrically conductive wires.

On the basis of this, the object of the invention is to further improve the insect protection devices known from the prior art and for this purpose specify an improved insect protection fabric, which can be produced inexpensively, has high dimensional stability and strength for the intended purpose and visually is as inconspicuous as possible and air-permeable in the installed state.

To achieve this object, the combination of features given in patent claims 1 and 14, respectively, is proposed. Advantageous refinements and developments of the invention are given in the dependent claims.

Accordingly, an insect protection fabric is proposed, in which the warp threads and weft threads lie one above the other in respectively separate thread planes and extend in a straight line. As a result of this layer structure with punctiform contact points or point contact only on a (half) side of the thread which remains the same, a very precise fabric with specific thread layers for warp and weft can be produced, even with a low thread thickness and correspondingly wider grid openings. High stability and in particular displacement resistance are achieved in the process compared with plain weave, as a result of which further processing in subsequent manufacturing steps is made easier, or even becomes possible at all. On account of the stretched warp and weft thread layers with threads extending in straight lines, the fabric only deforms under relatively high tensile loads compared with plain weave. The tearing strength thus increases considerably and a much improved stress-strain characteristic is achieved. Such a precise grid is important precisely in front of openings in buildings such as windows or doors, in order to ensure a protection function which is as inconspicuous as possible. High transparency in the installed state is a particular requirement in mechanical insect protection devices. If appropriate, special effect regions can have individual warp threads in plain weave, without substantially changing the overall structure of the fabric, however.

In an advantageous refinement, the holder is formed by a frame in which the insect protection fabric is mounted and which is preferably made of profile sections. Alternatively, it is also possible for the holder to be formed by a guide which laterally accommodates the insect protection fabric, which is in the form of a fabric web.

The crossing of the main threads on one side is made possible in that the weft threads and the warp threads lie one on the other as a single layer in each case, and so one side of the fabric is formed by the layer of weft threads and the other side of the fabric is formed by the layer of warp threads. In this arrangement, it is possible for the warp threads and the weft threads to extend substantially in straight lines in separate thread planes and to lie one on the other only on their mutually facing insides or inner half sides at the crossing points, while the outsides, which face away from one another, are looped around by the binding threads. The binding threads bring about the mutual normal force of the other two largely bend-free thread systems, and so there is good dimensional stability irrespective of the mesh size. The arrangement of the warp and weft threads in separate planes or layers also makes it possible to achieve high strength in the case of low thread thickness.

Advantageously, the binding threads have a diameter which is smaller, preferably by about half, than the warp and weft threads, the diameter of which can be reduced to a range less than 0.2 mm, preferably about 0.1 mm.

A further advantageous embodiment provides that the fabric is consolidated by cohesive connecting means, in particular adhesives or welds in the region of the crossing points, thereby achieving sufficient strength even in the case of an open-mesh structure. The binding threads afford advantages in two respects here, namely first a preconsolidation of the fabric for the subsequent adhesive bonding process and second a collecting structure for the adhesive, which then accumulates preferably in the crossing region.

It is also favorable, when the warp threads and weft threads are in the form of monofilaments having a preferably round cross section. As a result, greater precision in the thread layer and dimension is achieved compared with multifilaments. Round threads can be produced and processed easily because twisting in the longitudinal axis is not an issue.

Advantageously, the warp threads and weft threads consist of plastic, in particular of a polyester material such as PET. Threads of this kind can be produced at a lower cost and are also advantageous to the extent that they are very resistant to tearing and dimensionally stable with regard to temperature and humidity.

The warp threads and weft threads delimit openings in the fabric, and so the latter is still easy to see through and has good air permeability. For insect shielding, it is advantageous when the openings in the fabric have a clear width of 0.3 to 3 mm, preferably 0.8 to 1.2 mm in both directions. In this case, it should be borne in mind that in the case of thinner threads, the clear width can be reduced correspondingly, without the fabric becoming visually conspicuous.

Particular use advantages can also result if the fabric is designed with varying thread thicknesses and/or thread densities and/or colors, in particular to create striped effects or local reinforcements. In principle, it is also possible to create striped effects by warp threads binding in plain weave in specific regions. An improvement can also be achieved by fabric or thread coatings, for example an antibacterial effect by coating with silver or an antistatic effect particularly by fluorocarbon finishing, and as a result the soiling tendency is also reduced.

Subject matter of the invention is also an insect protection fabric for an insect protection device in which the warp threads and weft threads lie one above the other in respectively separate thread planes and extend in a straight line.

In terms of the method, the object mentioned at the beginning is achieved in that weft threads are laid on one side on top of the warp threads and are linked to the warp threads by binding threads, and so the warp threads and weft threads lie one above the other as main threads in respectively separate thread planes and extend in a straight line, while the binding threads pass through both thread planes and loop around the main threads on the outside. The advantages already mentioned with respect to the device are achieved for the method product as a result. Consequently, the warp threads are also much shorter than the binding threads.

The invention is explained in more detail in the following text by means of an exemplary embodiment illustrated diagrammatically in the drawing, in which:

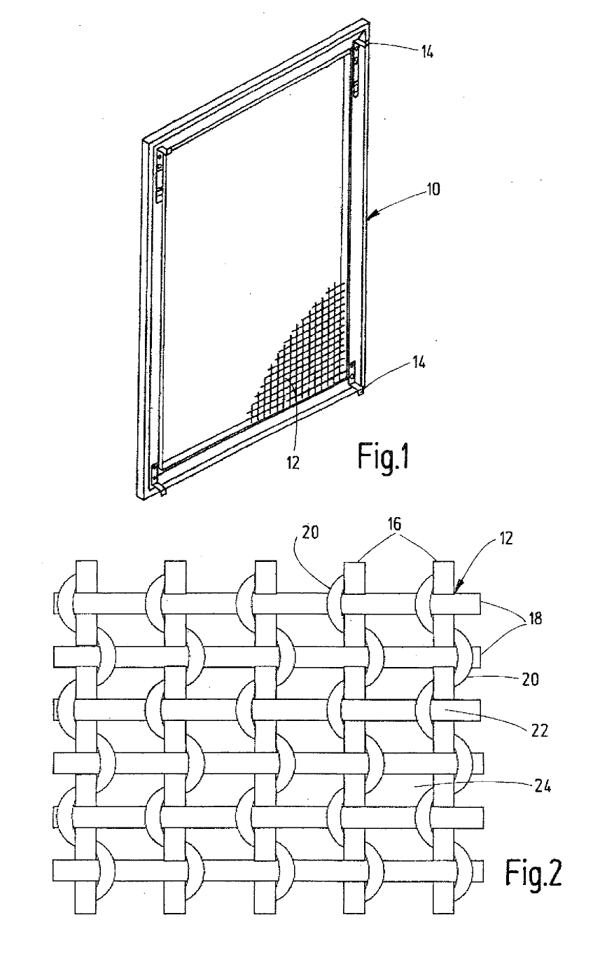

FIG. 1 shows a perspective illustration of an insect protection device as a mounting frame provided with an insect protection fabric for insertion into a window opening;

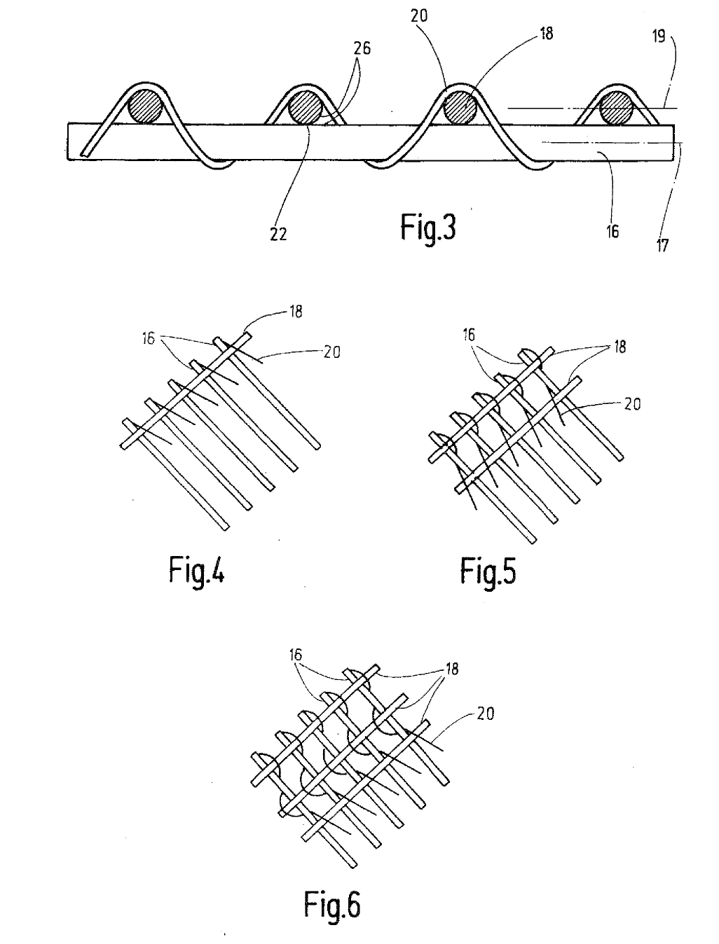

FIGS. 2 and 3 show a top view of a detail of the insect protection fabric formed of three thread systems and a section view thereof parallel to the warp threads; and

FIGS. 4 to 6 show the thread movement of the binding threads during the production of the insect protection fabric according to FIG. 2.

The insect protection device illustrated in FIG. 1 can be suspended outside a building window in order to prevent the entry of insects without substantially impairing the view to the outside and the passage of air. The device comprises a mounting frame 10 composed in a rectangular manner of profile members, a specially woven insect protection fabric 12 mounted therein, and suspension tabs 14 arranged in the corner regions of the mounting frame 10. These suspension tabs can be fitted so as to engage behind an edge of a window frame (not shown), and so the mounting frame 10 is held outside the window frame and window casements that open inwards can be opened in an unobstructed manner. Details of the installation principle are known per se and can also be found in DE 197 49 517, which is expressly incorporated by reference.

The mounting frame 10 has a weatherstrip groove for mounting the fabric 12 and in the suspended state can adjoin the outside of the window frame in an insect-tight manner by means of a peripheral seal (not shown), it also being easily possible to remove it, for example when it is not being used over the winter. Correspondingly adapted frame variants can also be used for other building openings, for example in front of doors or light shafts. Further use possibilities result from a design as a blind, in which the insect protection fabric 12 is held in the form of a windable fabric web in lateral guide rails. For such an embodiment, reference is also made to DE 19639478. It is also conceivable to hang the insect protection fabric in slat-like tracks on a holder, for example in front of outer doors. An adhesive or touch and close strip is also conceivable as a particularly simple holder.

As illustrated in FIGS. 2 and 3, the insect protection fabric 12 is formed of three thread systems. In the basic diagram shown, the warp threads 16 form the underside of the fabric while the weft threads lie on the warp threads 16 on one side or in a uniform manner on one half side and thus form the top side of the fabric. Provided as auxiliary threads for constructing the fabric are binding threads 20, which link the warp and weft threads together such that they cannot be displaced.

The fabric 12 is based on a kind of leno weave, the warp threads 16 lying substantially in a straight line as a supporting warp in a lower thread plane 17 spanned by the warp thread axes and the weft threads 18 lying substantially in a straight line in an upper thread plane 19 spanned by the weft thread axes, and the warp threads 16 and weft threads 18 being looped around on their outsides, which face away from one another, by binding threads 20 passing through the two thread planes 17, 19. Depending on the tensile force of the binding threads 20 and the flexural stiffness of the main threads, there may result a slight waviness in the warp and in the weft 16, 18, but this is less than the thread thickness.

The warp threads 16 and weft threads 18 thus lie one on the other in a punctiform manner with their mutually facing insides or inner half sides at crossing points 22, a high resistance to displacement being achieved already without additional linking means on account of friction under the tensile force of the binding threads 20. In order to further improve the fabric strength, an adhesive can be applied, for example by spraying, dipping or foam impregnation, and cured. The adhesive builds up preferably at the crossing points in the gap openings between the three thread systems 16, 18, 20. It is also conceivable to fuse or weld the crossing points 22. By way of example, thread systems having different melting points could be used, with the result that the main threads 16, 18 fuse while the binding threads 20 do not fuse. In principle, multicomponent yarns could also be used, with already fusible threads or thermoplastics having different melting points being present in the yarn.

Expediently, the binding threads 20 are much thinner than the main threads 16, 18, and so deformation acts largely only on the binding threads and the main threads are retained in their rectangular grid structure. By way of example, the binding thread diameter is less than 0.7 times, preferably around 0.5 times the main thread diameter. Typical values for the diameters are 0.1 mm for the warp and weft threads 16, 18 and 0.05 mm for the binding threads 20. In order, on the one hand, to ensure the necessary insect tightness and, on the other hand, not to restrict light transmission and the ability to see through unnecessarily, the openings 24 in the fabric should have a clear width between the inner edges of the mesh-forming threads of about 0.8 to 1.2 mm.

The grid structure should, here, be as precise as possible, so that uniform thread and mesh openings are produced. The spacing of the threads must be constant, not only within a mesh, but also from mesh to mesh. In order to achieve the necessary precision, a very precise thread run is necessary and can be achieved by stretched threads 16, 18 which lie in a punctiform manner one on the other in two planes with thread directions at right angles to one another and which do not loop around one another. Least visible here are regular, preferably square fabric openings.

Preferably, the fabric 12 consists of monofilament, synthetic textile threads or plastic threads 16, 18, 20, expediently having a round cross section. Monofilaments, as a result of their manufacture, have very precise and also constant thread diameters compared with multifilaments, and are more flexurally resistant with the same cross section. It is also conceivable to use angular cross sections, for instance in order to affect the reflection properties. A low cost thread material consists of plastics from the polyester family, in particular PET (polyethylene terephthalate).

In general, the thread material should have sufficient UV stability, for example on account of special stabilizers in the basic substance. In addition, it is favorable for the material to be dyed in a dark color or black, for example by adding carbon black or pigment, so that the UV light is already absorbed in the outer thread layers and does not lead to the destruction of molecules throughout. A black coloration also leads, just like a matt surface, to a reduction in disruptive reflections for the observer. Expediently, the threads are provided with a coating 26, for example of fluorocarbons, which reduces the soiling tendency.

FIGS. 4 to 6 illustrate the principle of thread movement during the production of the fabric 12. According to FIG. 4, the layer of warp threads 16 forms the lower shed during weaving. A weft thread 18 is laid in a stretched manner with its lower half side transversely over the warp threads 16 and is then fixed by the binding threads 20 in the region of the crossing points. Once the binding threads 20 have crossed onto the lower side of the fabric, the next weft insertion takes place (FIG. 5), the binding thread 20 then looping around in the opposite direction to the previous weft thread 18. This process can be continued, according to FIG. 6, over the length of the warp threads 16, the weft threads 18 being held at a mutual spacing in order to keep the mesh openings free.

1.-15. (canceled)

16. An insect protection device for shielding an opening such as a window or a door against entry of an insect, said insect protection device comprising:
a holder for placement in front of the opening; and
an insect protection fabric held in the holder and including warp threads and weft threads linked together in a manner of a grid by binding threads, the warp threads and the weft threads lying upon one another in separate thread planes and extending in a straight line.

17. The insect protection device of claim 16, wherein the holder includes a frame, said insect protection fabric being mounted to the frame.

18. The insect protection device of claim 17, wherein the frame is comprised of profile sections.

19. The insect protection device of claim 16, wherein the insect protection fabric is configured in the form of a fabric web, said holder having lateral guides for guiding the insect protection fabric.

20. The insect protection device of claim 16, wherein the weft threads and the warp threads lie upon one another such that the weft threads form a single layer on one side of the insect protection fabric and the weft threads form a single layer on another side of the insect protection fabric.

21. The insect protection device of claim 16, wherein the warp threads and the weft threads form a rectangular grid structure in the insect protection fabric and delimit openings having a clear width of 0.3 to 3 mm.

22. The insect protection device of claim 21, wherein the openings have a clear width of 0.8 to 1.2 mm.

23. The insect protection device of claim 16, wherein the warp threads and weft threads have confronting insides lying upon one another at crossing points.

24. The insect protection device of claim 16, wherein the warp threads and weft threads have outsides, which face away from one another, said binding threads being looped around the outsides of the warp threads and weft threads.

25. The insect protection device of claim 16, wherein the binding threads have a diameter which is smaller than a diameter of the warp and weft threads.

26. The insect protection device of claim 25, wherein the diameter of the binding threads is about half the diameter of the warp and weft threads.

27. The insect protection device of claim 23, wherein the insect protection fabric is consolidated by a material joint in a region of the crossing points.

28. The insect protection device of claim 27, wherein the material joint is realized by an adhesive or a weld point.

29. The insect protection device of claim 16, wherein the warp threads and weft threads are configured in the form of monofilaments.

30. The insect protection device of claim 29, wherein the monofilaments has a round cross section.

31. The insect protection device of claim 16, wherein the warp threads and weft threads are made of plastic.

32. The insect protection device of claim 31, wherein the plastic is polyester material.

33. The insect protection device of claim 32, wherein the polyester material is PET.

34. The insect protection device of claim 16, wherein the insect protection fabric is designed with varying thread thickness and/or thread density and/or color and/or with an antibacterial fabric coating and/or antistatic fabric coating.

35. An insect protection fabric for an insect protection device for shielding an opening such as a window or door against entry of an insect, said insect protection fabric comprising warp threads and weft threads linked together in a manner of a grid by binding threads, the warp threads and the weft threads lying upon one another in separate thread planes and extending in a straight line

36. A method for producing an insect protection fabric for an insect protection device for shielding an opening such as a window or door against entry of an insect, said method comprising the steps of:
laying weft threads stretched in a straight line upon warp threads in a manner of a grid; and
connecting the weft threads with the warp threads by binding threads such that the warp threads and the weft threads lie upon one another in separate thread planes.

37. The method of claim 36, wherein the binding threads pass through the thread planes and are looped around the warp threads and weft threads on their outsides, which face away from one another.
